(19) United States
(12) Patent Application Publication
(10) Pub. No.: US 2026/0126344 A1
(43) Pub. Date: May 7, 2026

(54) DETECTION OF OPTICAL FIBER SEGMENT FAILURE USING OPTICAL SIGNAL LOOPBACK

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 19/379,002

(22) Filed: Nov. 4, 2025

Related U.S. Application Data
(60) Provisional application No. 63/715,930, filed on Nov. 4, 2024.

(51) Int. Cl. G01M 11/00; H04B 10/071

(52) U.S. Cl. CPC G01M 11/31; H04B 10/071

(57) ABSTRACT

Novel tools and techniques are provided for detection of optical fiber segment failure using optical signal loopback. In examples, a plurality of devices is placed within an optical communication system, each device being communicatively coupled with a next device by one of a plurality of optical fiber segments, along a transmission path between an optical signal source and a destination optical terminal. The optical signal source transmits optical signals along the transmission path to each device in sequence. Each device, when in a first state, causes transmission of the optical signals to continue along a next optical fiber segment. When in a second state, each device causes at least a portion of the optical signal to be reflected along the transmission path back toward the optical signal source. A detector detects which optical fiber segment has a failure based on which device failed to send back a reflected optical signal.

### CROSS-REFERENCE TO RELATED APPLICATIONS

This application claims the benefit of U.S. Provisional Application No. 63/715,930 filed Nov. 4, 2024, entitled “Detection of Optical Fiber Segment Failure Using Optical Signal Loopback,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing detection of optical fiber segment failure using optical signal loopback.

### BACKGROUND

Fiber optic networks can fail due to electronic or optical components, which makes recovery processes difficult in terms of identifying failed components during power loss scenarios. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing detection of optical fiber segment failure using optical signal loopback, in accordance with various embodiments.

FIGS. 2A-2J depict various example system configurations for implementing detection of optical fiber segment failure using optical signal loopback, in accordance with various embodiments.

FIG. 3 depicts a flow diagram illustrating an example method for implementing detection of optical fiber segment failure using optical signal loopback, in accordance with various embodiments.

FIG. 4 depicts a flow diagram illustrating another example method for implementing detection of optical fiber segment failure using optical signal loopback, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In fiber optic communications systems, when a break in the system occurs, it is difficult to identify or isolate where the problem is. This is compounded by use of components that are completely passive (such as in passive optical networks). The present technology provides for detection of optical fiber segment failure using optical signal loopback that addresses this issue.

In examples, an optical signal source transmits a first optical signal over at least a first segment of a plurality of optical fiber segments of an optical fiber cable to each device, in sequence, among a plurality of devices. Each device is communicatively coupled with a next device by one of the plurality of optical fiber segments of the optical fiber cable, the plurality of devices and the plurality of optical fiber segments defining an optical fiber transmission path between the optical signal source and at least one destination optical terminal. For each device, in sequence, that device receives the first optical signal, and while in a first state, causes transmission of the first optical signal to continue along the optical fiber transmission path over a next segment among the plurality of optical fiber segments of the optical fiber cable toward the at least one destination optical terminal. The optical signal source transmits a second optical signal over at least the first segment of the optical fiber cable to each device, in sequence. The second optical signal contains a first control signal that triggers at least one device to switch states from the first state to a second state. For each device, in sequence, that device receives the second optical signal, and based on a determination that the first control signal contained in the second optical signal is directed to that device, switches from the first state to the second state. While in the second state, that device causes at least a portion of the second optical signal to be reflected back along the optical fiber transmission path over at least the first segment of the optical fiber cable back toward the optical signal source. A main detector, which is located proximal to the optical signal source, detects which optical fiber segment among the plurality of optical fiber segments has a break, by determining which device among the plurality of devices fails to send back a reflected optical signal. In this manner, a passive component is created and used that is capable of triggering momentary loopback capability to identify a clean path between two optical components.

These and other aspects of the optical fiber segment failure detection using optical signal loopback are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a first device that is placed along an optical fiber transmission path, a first optical signal that is transmitted over at least a first segment of an optical fiber cable from an optical signal source; and directing, by the first device, transmission of the first optical signal, by: (a) when in a first state, causing transmission of the first optical signal to continue along the optical fiber transmission path over at least a second segment of the optical fiber cable toward a destination optical terminal; and (b) when in a second state, causing at least a portion of the first optical signal to be reflected back along the optical fiber transmission path over at least the first segment of the optical fiber cable back toward the optical signal source, the first optical signal that is reflected back being detected using a main detector that is located between the optical signal source and the first device.

In another aspect, the technology relates to a system, including an optical signal source; a main detector that is located proximal to the optical signal source; and a plurality of devices. Each device is communicatively coupled with a next device by one of a plurality of optical fiber segments of an optical fiber cable. The plurality of devices and the plurality of optical fiber segments define an optical fiber transmission path between the optical signal source and at least one destination optical terminal. The optical signal source transmits optical signals along the optical fiber transmission path over at least a first segment of the plurality of optical fiber segments of the optical fiber cable to each device in sequence. Each device directs transmission of the optical signals, by: (a) when in a first state, causing transmission of the optical signals to continue along the optical fiber transmission path over a next segment among the plurality of optical fiber segments of the optical fiber cable toward the at least one destination optical terminal; and (b) when in a second state, causing at least a portion of the optical signal to be reflected back along the optical fiber transmission path over at least the first segment of the optical fiber cable back toward the optical signal source. The main detector detects which optical fiber segment among the plurality of optical fiber segments has a break, by determining which device among the plurality of devices fails to send back a reflected optical signal.

In yet another aspect, the technology relates to a method, including transmitting, by an optical signal source, a first optical signal over at least a first segment of a plurality of optical fiber segments of an optical fiber cable to each device, in sequence, among a plurality of devices. Each device is communicatively coupled with a next device by one of the plurality of optical fiber segments of the optical fiber cable, the plurality of devices and the plurality of optical fiber segments defining an optical fiber transmission path between the optical signal source and at least one destination optical terminal. The method further includes, for each device, in sequence, receiving, by that device, the first optical signal; and while in a first state, causing, by that device, transmission of the first optical signal to continue along the optical fiber transmission path over a next segment among the plurality of optical fiber segments of the optical fiber cable toward the at least one destination optical terminal. The method further includes transmitting, by the optical signal source, a second optical signal over at least the first segment of the optical fiber cable to each device, in sequence. The second optical signal contains a first control signal that triggers at least one device to switch states from the first state to a second state. The method further includes, for each device, in sequence, receiving, by that device, the second optical signal; based on a determination that the first control signal contained in the second optical signal is directed to that device, switching, by that device, from the first state to the second state; and while in the second state, causing at least a portion of the second optical signal to be reflected back along the optical fiber transmission path over at least the first segment of the optical fiber cable back toward the optical signal source. The method further includes detecting, by a main detector that is located proximal to the optical signal source, which optical fiber segment among the plurality of optical fiber segments has a break, by determining which device among the plurality of devices fails to send back a reflected optical signal.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

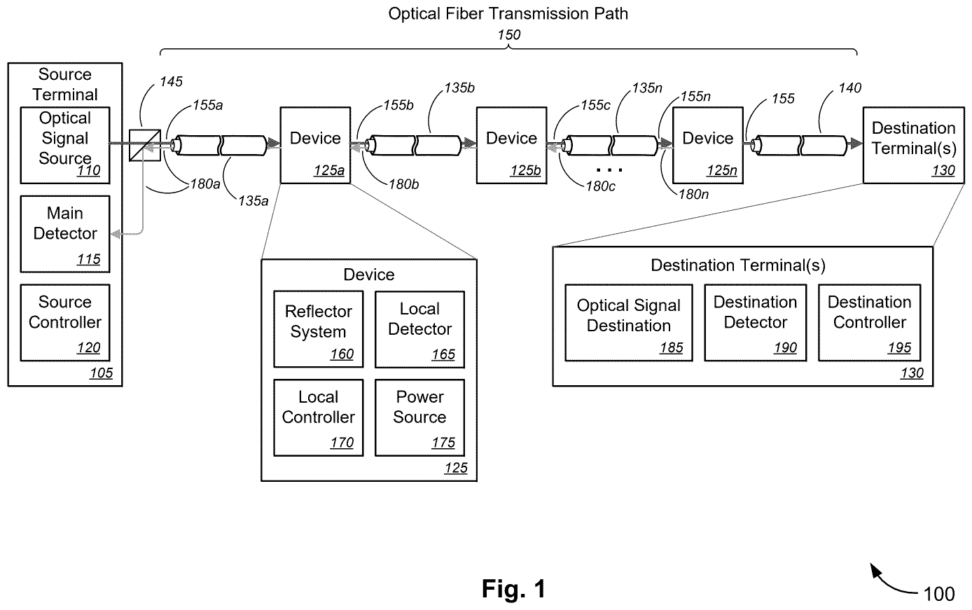

Turning to the embodiments as illustrated by the drawings, FIGS. 1-5 illustrate some of the features of methods, systems, and apparatuses for implementing detection of optical fiber segment failure using optical signal loopback, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

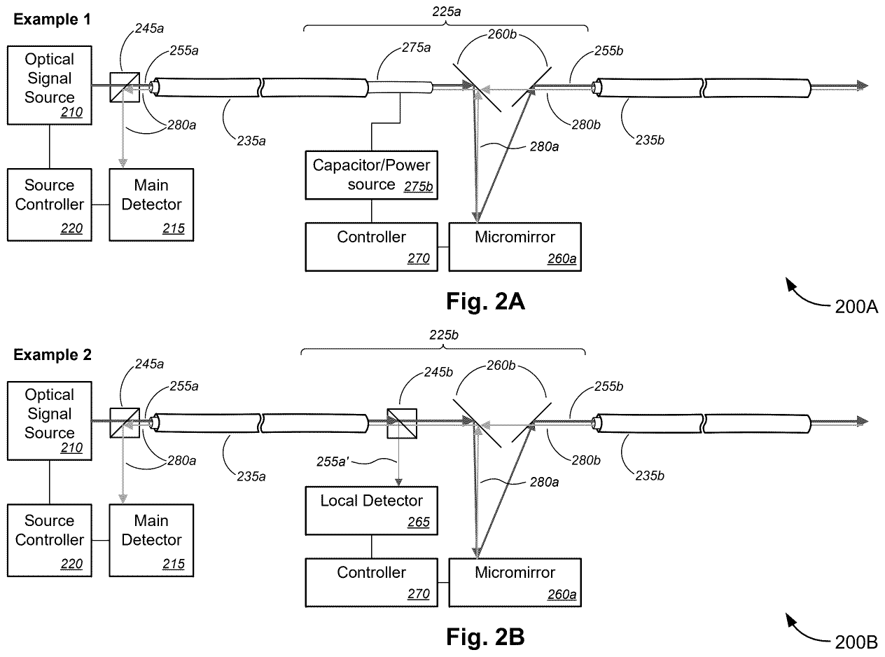

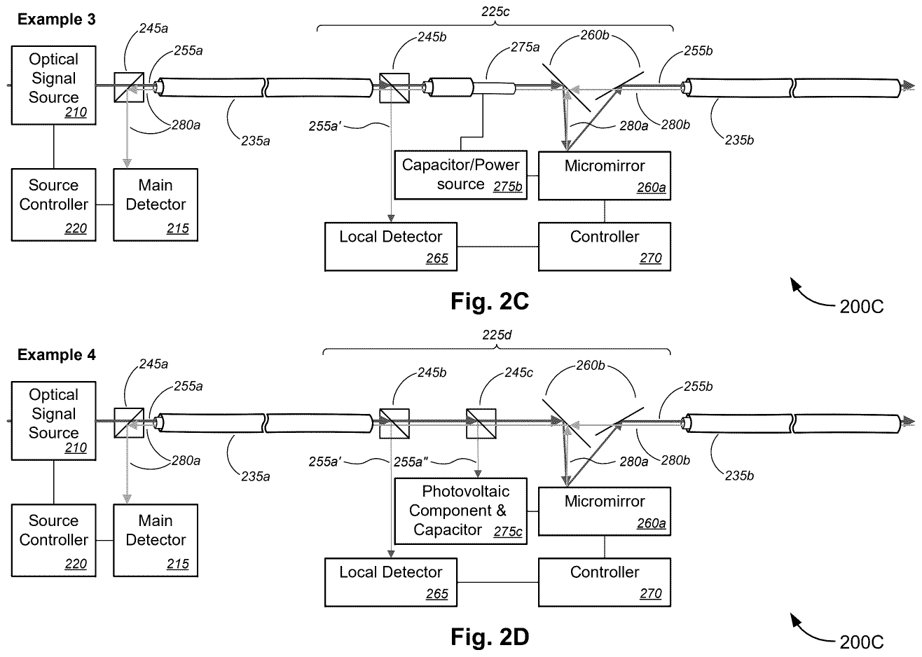

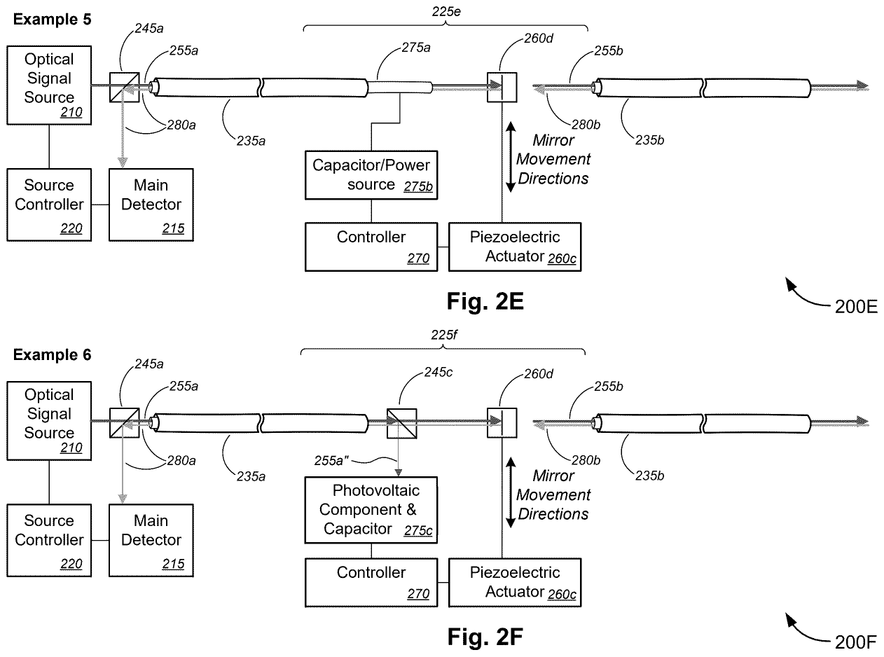

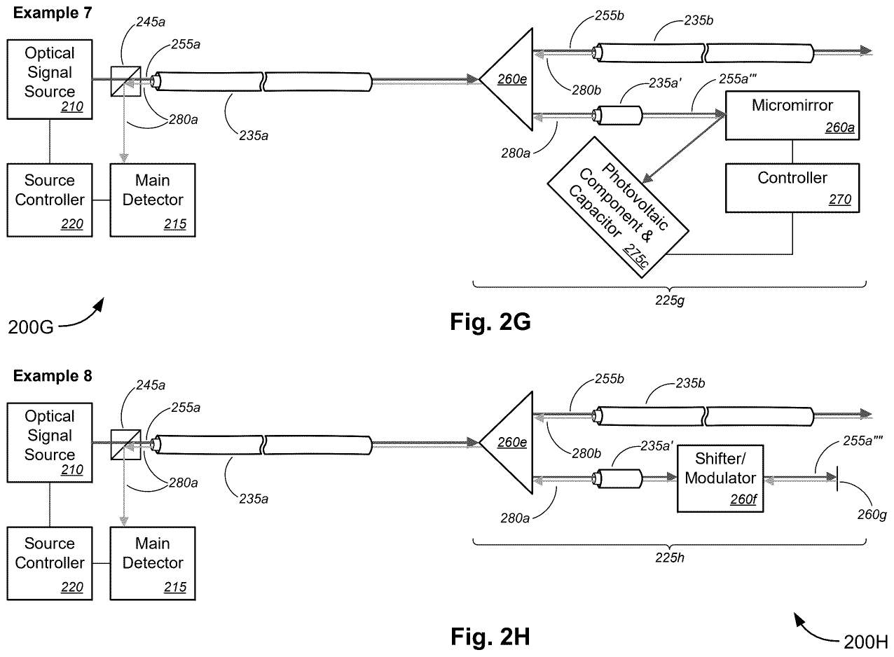

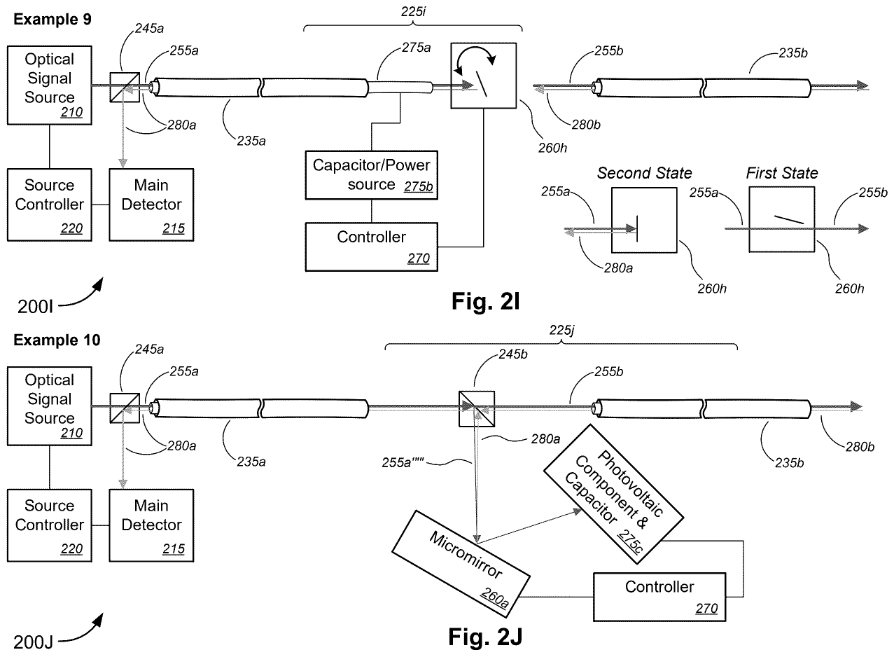

With reference to the figures, FIG. 1 depicts an example system 100 for implementing detection of optical fiber segment failure using optical signal loopback, in accordance with various embodiments. In examples, system 100 includes a source terminal 105, which may include an optical signal source 110, a main detector 115, and, in some cases, a source controller 120 as well. System 100 further includes a plurality of devices 125a-125n (collectively, “devices 125” or the like), a destination terminal(s) 130, a plurality of optical fiber segments 135a-135n (collectively, “optical fiber segments 135” or the like), a destination optical fiber segment 140, and at least one optical splitter 145. In some examples, each optical fiber segment 135 is a separate or discrete optical fiber cable. In some cases, the optical fiber segments 135a-135n can collectively be thought of as segments of one optical fiber cable or one optical fiber connection between source terminal 105 and destination terminal(s) 130. Each device 125 is communicatively coupled with a next device 125 among the plurality of devices 125b-125n by one of the plurality of optical fiber segments 135a-135n (and corresponding optical fiber ports, connectors, and/or adapters, etc.). Similarly, device 125a communicatively couples with optical signal source 110 via optical fiber segment 140, and, in some cases, optical splitter 145 as well. Likewise, device 125n communicatively couples with destination terminal(s) 130 via destination optical fiber segment 140. In some instances, the plurality of devices 125a-125n and the plurality of optical fiber segments 135a-135n (and, in some cases, the destination optical fiber segment 140 as well) define an optical fiber transmission path 150 between the optical signal source 110 (or the source terminal 105) and at least one destination optical terminal 130. In examples, each device 125 may include a reflector system 160, a local detector 165, a local control 170, and/or a power source 175, examples of configurations of which are shown and described in detail below with respect to FIGS. 2A-2J. In some examples, the destination terminal(s) 130 may each include an optical signal destination 185, a destination detector 190, and, in some cases, a destination controller 195 as well.

In examples, optical signal source 110 transmits an optical signal(s) 155 along the optical fiber transmission path 150 toward the destination terminal(s) 130, via optical splitter 145 and via at least a first optical fiber segment 135a. Each device 125, in sequence, directs transmission of the optical signals, by: (a) when in a first state, causing transmission of the optical signal(s) 155 to continue along the optical fiber transmission path 150 over a next segment among the plurality of optical fiber segments 135a-135n toward the destination optical terminal(s) 130; and (b) when in a second state, causing at least a portion of the optical signal(s) 155 to be reflected back as reflected optical signal(s) 180 along the optical fiber transmission path 150 over at least the first optical fiber segment 135a back toward the optical signal source 110. In examples, the optical signal(s) 155 that is emitted from the optical signal source 110 may change during transmission along the optical fiber transmission path 150, e.g., due to signal losses, optical signal splitting, absorption by photovoltaic components, etc. As such optical signal(s) 155 may include optical signal(s) 155a that is received by a first device 125a, optical signal(s) 155b that is relayed by the first device 125a and is received by a second device 125b, optical signal(s) 155c that is relayed by the second device 125b, and so on, to optical signal(s) 155n that is received by the N^{th} device 125n. Optical signal(s) 155a is reflected by the first device 125a (while in the second state) as reflected optical signal(s) 180a, while optical signal(s) 155b is reflected by the second device 125b (while in the second state) as reflected optical signal(s) 180b, and so on, with optical signal(s) 155n being reflected by the N^{th} device 125n (while in the second state) as reflected optical signal(s) 180n.

The main detector 115 receives reflected optical signals 180a-180n, and detects which optical fiber segment among the plurality of optical fiber segments 135a-135n has a break, by determining which device among the plurality of devices 125a-125n fails to send back a reflected optical signal 180a-180n. For example, if the first device 125a sends back a reflected optical signal(s) 180a, but the second device 125b fails to send back reflected optical signal(s) 180b, then the main detector 115 and/or source controller 120 may determine that an issue (e.g., a break in the fiber cable) has likely occurred along the second optical fiber segment 135b. In another example, if the first device 125a sends back a reflected optical signal(s) 180a, but the second device 125b fails to send back reflected optical signal(s) 180b, and at least one device beyond the second device 125b (e.g., at least one of devices 125c-125n) sends back a corresponding at least one reflected optical signal(s) among optical signals 180c-180n, then the main detector 115 and/or source controller 120 may determine that an issue has likely occurred with the second device 125b itself (e.g., something related to its reflector system).

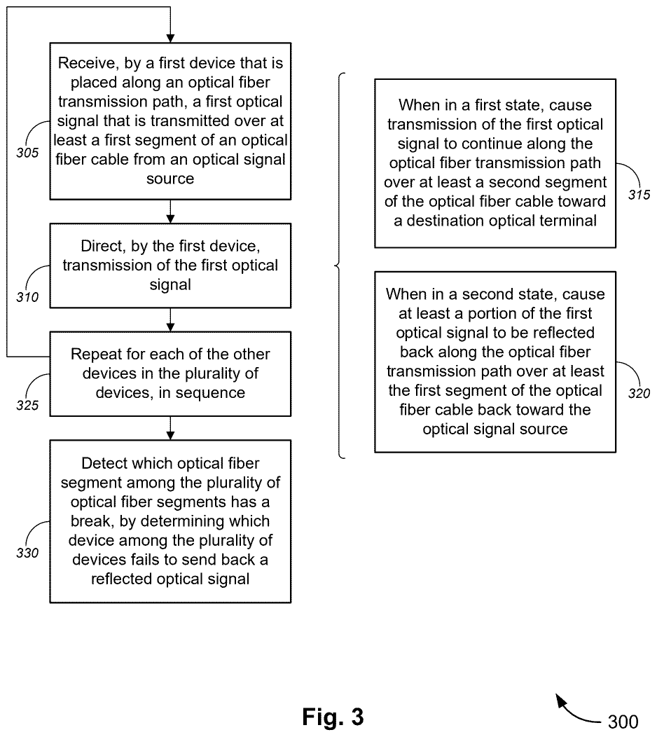

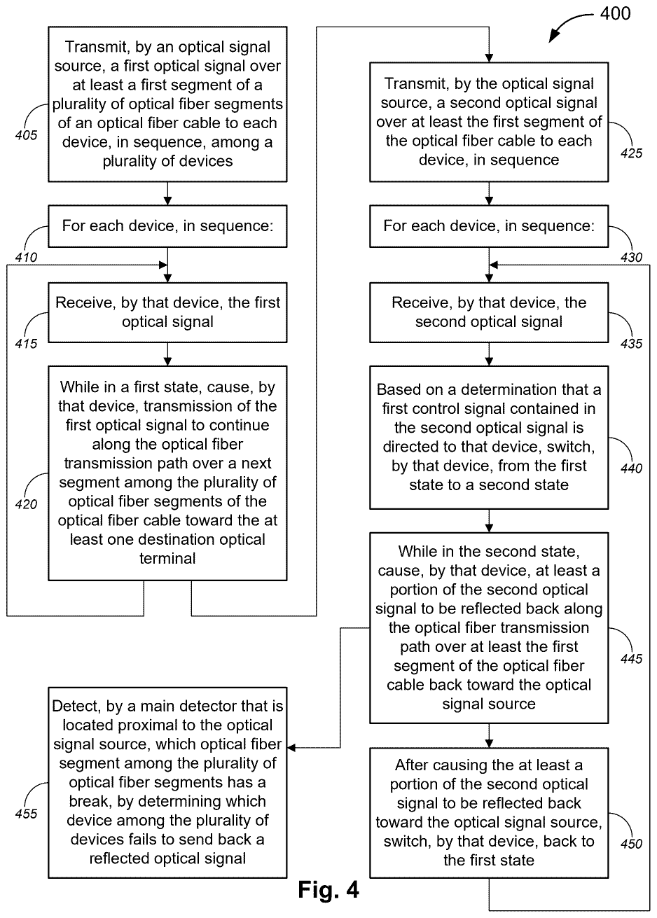

In operation, main detector 115 and/or source controller 120 (collectively, “computing system”), and/or each device 125, may perform methods for implementing detection of optical fiber segment failure using optical signal loopback, as described in detail with respect to FIGS. 2-4. For example, example system configurations 200A-200J as described below with respect to FIGS. 2A-2J, and example methods 300 and 400 described below with respect to FIGS. 3 and 4, respectively, may be applied with respect to the operations of system 100 of FIG. 1.

FIGS. 2A-2J (collectively, “FIG. 2”) depict various example system configurations 200A-200J for implementing detection of optical fiber segment failure using optical signal loopback, in accordance with various embodiments. In some embodiments, optical signal source 210, main detector 215, source controller 220, devices 225a-225j, optical fiber segments 235a and 235b, optical splitters 250a-250c, optical signals 255a and 255b, reflector system components 260a-260h (collectively, “reflector system components 260” or the like), local detector 265, controller 270, power sources 275a-275c, and reflected optical signals 280a and 280b of FIG. 2 may be similar, if not identical, to the optical signal source 110, main detector 115, source controller 120, devices 125a-125n, optical fiber segments 135a-135n, optical splitter 145, optical signals 155a-155n, reflector system 160, local detector 165, local controller 170, power source 175, and reflected optical signals 180a-180n, respectively, of system 100 of FIG. 1, and the description of these components of system 100 of FIG. 1 are similarly applicable to the corresponding components of FIG. 2.

In example system configurations 200A-200J (i.e., Examples 1 through 10) of FIGS. 2A-2J, source controller 220 controls optical signal source 210 to transmit a first optical signal 255a (depicted as a thick, dark gray arrow) over at least optical fiber segment 235a, via optical splitter 245a. Each of devices 225a-225j (collectively, “devices 225” or the like) corresponds to any one of devices 125a-125n of FIG. 1. That is, FIGS. 2A-2J are intended to show operation of devices 225 regardless of whether there are any intervening similar devices 225 between that device 225 and the optical signal source 210. In this manner, optical fiber segment 235a corresponds to the first optical fiber segment that is closest to optical signal source 210, while optical fiber segment 235b in FIGS. 2A-2J corresponds to the optical fiber segment just beyond the device 225 (a corresponding one of devices 225a-225j), or on the side of the device 225 that is opposite to optical fiber segment 235a. Reflected optical signal(s) 280a (depicted as a thin or thick, light dark gray arrow) is directed, by optical splitter 245a, from optical fiber segment 235a toward main detector 215, which detects the reflected optical signal(s) 280a and, in some cases, communicates with (or is controlled by) source controller 220.

When in the first state, each device 225 causes transmission of the optical signal(s) 255a to continue along the optical fiber transmission path as optical signal(s) 255b over a next segment among the plurality of optical fiber segments (in this case, over optical fiber segment 235b). Reflected optical signals (e.g., reflected optical signal(s) 280b) from downstream devices (e.g., one of devices 125b-125n of FIG. 1) are carried over optical fiber segment 235b, and through device 225, for transmission back toward optical signal source 210 (i.e., over optical fiber segment 235a to main detector 215 via optical splitter 245a). In some examples, the optical splitter 245a includes at least one of a two-way mirror, a beam splitter, and/or a beam-splitting polarizer, or the like. A two-way mirror appears transparent from one side and reflective from the other, transmitting light from one side to the other side (in this case, transmitting optical signals from the optical signal source-side (transparent side) to the optical fiber transmission path-side (reflective side)), but reflects light from the other side (in this case, from the optical fiber transmission path-side (reflective side)). A beam splitter (e.g., a cube beam splitter or a plate beam splitter) splits an incident beam into a transmitted portion and a reflected portion, the proportions of which can be 50/50, 60/40, 70/30, 80/20, or 90/10% transmitted/reflected, with the reverse direction having the same proportions. A beam-splitting polarizer splits an incident beam, with light having one polarization being transmitted and light having another polarization being reflected.

In the various example system configurations 200A-200J (i.e., Examples 1 through 10) of FIGS. 2A-2J, each device 225 uses one among various different combination of components in one of various different configurations or arrangements. The components of each device 225 (like device 125 of FIG. 1) may include a reflector system, a local detector, a local controller, and/or a power source, corresponding to reflector system 160, local detector 165, local controller 170, and/or power source 175, respectively, of FIG. 1.

In examples, the reflector system may include at least one of a micromirror device 260a (as shown, e.g., in FIGS. 2A-2D, 2G, and 2J), mirrors/splitters 260b (including two-way mirrors, beam splitters, and/or beam-splitting polarizers, etc.) (as shown, e.g., in FIGS. 2A-2D), piezoelectric actuator (or electromechanical actuator) 260c and corresponding lateral-moving mirror 260d (as shown, e.g., in FIGS. 2E and 2F), an unbalanced optical fiber splitter 260e (as shown, e.g., in FIGS. 2G and 2H), a shifter/modulator 260f (as shown, e.g., in FIG. 2H), mirror 260g (as shown, e.g., in FIG. 2H), and/or tiltable mirror 260h (as shown, e.g., in FIG. 2I), and/or the like.

In examples, a micromirror device is a microelectromechanical system (“MEMS”) device whose states are controlled electronically, and includes microscopic mirrors arranged in a matrix. In the case of digital micromirror devices, the mirrors have two states, “on” and “off” (hence, “digital”), where, in a first state, the mirrors are configured to reflect light in one direction, and, in a second state, the mirrors are configured to reflect light in another different direction. The micromirror devices 260a, as described herein with respect to FIGS. 2A-2D, 2G, and 2J, are configured to switch between reflecting optical signals to be transmitted over the optical fiber transmission path toward the destination optical terminal (in the first state) and reflecting optical signals to be transmitted over the optical fiber transmission path back toward the optical signal source (in the second state). In examples, the micromirror device 260a may be configured to switch states in response to receiving a control signal, such as (i) a signal to switch between the first state and the second state, (ii) a signal to switch from the first state to the second state, or (iii) a signal to switch from the second state to the first state. In some examples, the control signal may include one of:
(a) a first control signal contained in an optical signal (e.g., optical signal 255a) that is transmitted from the optical signal source 210;
(b) a second control signal that is sent by a local detector (e.g., local detector 265), which is coupled to and in proximity of the device 225 containing the micromirror device 260a, that detects the first control signal contained in the optical signal from the optical signal source 210; or
(c) a third control signal that is sent by the local detector that detects a change in power level of optical signals transmitted over the optical fiber transmission path (e.g., optical fiber transmission path 150 of FIG. 1).

An unbalanced optical fiber splitter 260e splits an optical fiber cable into two or more optical fiber cables that carry optical signals at different power levels. In some examples, the unbalanced optical fiber splitter 260e includes a planar lightwave circuit (“PLC”) splitter that uses silica optical waveguide technology to distribute optical signals. The unbalanced optical fiber splitter 260e can be a 60/40, 70/30, 75/25, 80/20, 85/15, or 90/10%, etc., with one or more first outputs evenly splitting the 60, 70, 75, 80, 85, or 90% optical power while one or more second outputs evenly splitting the 40, 30, 25, 30, 15, or 10% optical power. For example, with a 1:2 ratio splitter (one cable splitting into two), a 70/30 unbalanced optical fiber splitter splits the optical power such that one output cable receives 70% of the optical power while the other output cable receives 30% of the optical power, not counting losses (e.g., insertion loss, etc.). In comparison, a balanced optical fiber splitter distributes power evenly among all output cables.

Referring to example system configurations 200A (or Example 1) in FIG. 2A, device 225a includes an optical fiber segment portion 275a having an inner surface lined with or made from photovoltaic material that converts optical power from the optical signal being transmitted through it into electrical power. Device 225a further includes a capacitor-based power source 275b, a controller 270, a micromirror device 260a, and mirrors/splitters 260b. The optical fiber segment portion 275a either is connected between the optical fiber segment 235a and a port/connector of device 225a or is formed as part of the optical fiber segment 235a close to the port/connector of device 225a. In operation, when the device 225a is in the first state, optical signal(s) 255a that is transmitted from optical signal source 210 over optical fiber segment 235a passes through optical fiber segment portion 275a to be reflected by a first of the mirrors/splitters 260b toward micromirror device 260a, which reflects the optical signal(s) 255a toward a second of the mirrors/splitters 260b, which reflects the optical signal(s) 255a as optical signal(s) 255b through optical fiber segment 235b (via another port/connector of device 225a) toward the destination terminal. The optical power collected by the optical fiber segment portion 275a from the passing optical signal(s) 255a is converted into electrical power and stored in the capacitor-based power source 275b.

When the power of the optical signal(s) 255a diminishes (e.g., due to the optical signal source 210 outputting a lower-power optical signal as a control signal, etc.) to a point that the capacitor-based power source 275b is no longer being charged and begins to discharge (e.g., below a threshold power level), the capacitor-based power source 275b signals controller 270, which causes the micromirror device 260a to switch from the first state to the second state. When in the second state, the micromirror device 260a reflects at least a portion of the optical signal(s) 255a as reflected optical signal(s) 280a back toward the first of the mirrors/splitters 260b, which reflects the reflected optical signal(s) 280a back along the optical fiber segment 235a toward optical splitter 245a, which reflects the reflected optical signal(s) 280a toward main detector 215. When the power of the optical signal(s) 255a once again rises to a point that the capacitor-based power source 275b is once again charged (e.g., above the threshold power level), the capacitor-based power source 275b signals controller 270, which causes the micromirror device 260a to switch from the second state back to the first state.

Reflected optical signal(s) 280b reflected from a downstream device 255, depending on the type of mirror or splitter of the mirrors/splitters 260b, either passes straight through mirrors/splitters 260b on the return path (as depicted in FIG. 2A by the light gray arrow corresponding to reflected optical signal(s) 280a passing straight through the second and the first of the mirrors/splitters 260b, or reflects off the second of the mirrors/splitters 260b, off micromirror device 260a (when in the first state), and off the first of the mirrors/splitters 260b, back along optical fiber segment 235a toward main detector 215 via optical splitter 245a. In examples, either the optical fiber segment portion 275a in successive downstream devices 225 is configured to absorb and convert less optical power (e.g., due to small size or a load being added to drain the power) or the capacitor-based power source 275b is configured to store less power or discharge sooner (e.g., due to smaller capacitors being used or a load being added to drain the power) for successive sets of these power source components 275 in successive downstream devices 225. In this manner, devices 225 furthest downstream will be caused to switch to from the first state to the second state first, so that the reflected optical signal(s) 280b can pass through upstream devices 225 when they are in the first state. The source controller 220 and/or the main detector 215 can then identify which devices 225 have successfully sent back reflected optical signals 280, and which have failed to do so, thus narrowing a likely location of a fault or break in the system (if any).

Turning to example system configurations 200B (or Example 2) in FIG. 2B, device 225b differs from device 225a in FIG. 2A, in that instead of the optical fiber segment portion 275a and the capacitor-based power source 275b, device 225b further includes optical splitter 245b and local detector 265. The optical splitter 245b reflects a portion of optical signal(s) 255a toward local detector 265, while allowing a majority of optical signal(s) 255a to pass through toward the first of the mirrors/splitters 260b. In the case that optical signal(s) 255a contains a control signal 255a′ that is directed to device 225b to change states, then controller 270 causes micromirror device 260a to switch from the first state to the second state, which causes micromirror device 260a to reflect optical signal(s) 255a as reflected optical signal(s) 280a back toward the first of the mirrors/splitters 260b. Example system configurations 200B (or Example 2) in FIG. 2B is otherwise similar, if not identical, to example system configurations 200A (or Example 1) in FIG. 2A in terms of operation and function in the first and second states of devices 225a and 225b.

Device 225c of example system configurations 200C (or Example 3) in FIG. 2C combines the features of devices 225a and 225b. For device 225c, optical fiber segment portion 275a absorbs optical power from the optical signal(s) 255a passing through it, and converts the optical power into electrical power that is stored in capacitor-based power source 275b and capacitor-based power source 275b is used to power the micromirror device 260a to enable switching between the first and second states. Like with device 225b of FIG. 2B, device 225c causes controller 270 to cause the micromirror device 260a to switch states between the first and second states in response to the local detector 265 detecting control signal 255a′ contained in control signal(s) 255a, a portion of which is split and directed toward local detector 265 via optical splitter 245b.

Device 225d of example system configurations 200D (or Example 4) in FIG. 2D is similar, if not identical, to device 225c of example system configurations 200C (or Example 3) in FIG. 2C, except that instead of the optical fiber segment portion 275a and the capacitor-based power source 275b, device 225d further includes optical splitter 245c and photovoltaic component and capacitor-based power source 275c. Optical splitter 245c splits the majority of optical signal(s) 255a (after being split by optical splitter 245b) into optical signal 255a″ whose optical power is absorbed and converted into electrical power that is stored and used to power the micromirror device 260a. Example system configurations 200C (or Example 3) in FIG. 2C and example system configurations 200D (or Example 4) in FIG. 2D are otherwise similar, if not identical, to example system configurations 200A (or Example 1) in FIG. 2A and Example system configurations 200B (or Example 2) in FIG. 2B in terms of operation and function in the first and second states of devices 225a-225d.

With reference to example system configurations 200E (or Example 5) in FIG. 2E, device 225e includes the optical fiber segment portion 275a and the capacitor-based power source 275b of device 225a of FIG. 2A, but instead of micromirror device 260a and the mirrors/splitters 260b, device 225e further includes a piezoelectric actuator (or an electromechanical actuator) 260c and a corresponding lateral-moving mirror 260d. In operation, when the device 225e is in the first state, the lateral-moving mirror 260d is moved out of the path of the optical signals transmitted through the optical fiber transmission path along optical fiber segments 235a and 235b. Similar to the case in Example 1 of FIG. 2A, when the power of the optical signal(s) 255a diminishes to a point that the capacitor-based power source 275b is no longer being charged and begins to discharge (e.g., below a threshold power level), the capacitor-based power source 275b signals controller 270. In this case, controller 270 causes the piezoelectric actuator (or an electromechanical actuator) 260c to switch from the first state to the second state, by causing the lateral-moving mirror 260d to shift into the path of the optical signals transmitted through the optical fiber transmission path along optical fiber segments 235a. The lateral-moving mirror 260d reflects the optical signal(s) 255a as reflected optical signal 280a. When the power of the optical signal(s) 255a once again rises to a point that the capacitor-based power source 275b is once again charged (e.g., above the threshold power level), the capacitor-based power source 275b signals controller 270, which causes the piezoelectric actuator (or an electromechanical actuator) 260c to switch from the second state back to the first state, by causing the lateral-moving mirror 260d to shift out of the path of the optical signals transmitted through the optical fiber transmission path along optical fiber segments 235a.

Device 225f of example system configurations 200F (or Example 6) in FIG. 2F is similar, if not identical, to device 225e of example system configurations 200E (or Example 5) in FIG. 2E, except that instead of the optical fiber segment portion 275a and the capacitor-based power source 275b, device 225f further includes optical splitter 245c and photovoltaic component and capacitor-based power source 275c. Optical splitter 245c splits the optical signal(s) 255a into optical signal 255a″ whose optical power is absorbed and converted into electrical power that is stored and used to power the controller 270, which in turn controls the piezoelectric actuator (or an electromechanical actuator) 260c to switch between the first state and the second state, by causing the lateral-moving mirror 260d to shift into or out of the path of the optical signals transmitted through the optical fiber transmission path along optical fiber segments 235a. The lateral-moving mirror 260d (when in the path of the optical signals; i.e., when in the first state) reflects the optical signal(s) 255a as reflected optical signal 280a. In some example, the controller 270 controls the piezoelectric actuator (or an electromechanical actuator) 260c to switch between the first state and the second state according to one of the following:
(A) a separate control signal (either from the optical signal source in the form of a control signal like control signal(s) 255a′ of FIGS. 2B and 2D, or from another control source);
(B) a power-based control like in example system configurations 200A (or Example 1) in FIG. 2A or in example system configurations 200E (or Example 5) in FIG. 2E where discharging and charging of the photovoltaic component and capacitor-based power source 275c causes the controller 270 to cause the piezoelectric actuator (or an electromechanical actuator) 260c to switch from the first state to the second state and from the second state back to the first state, respectively; or
(C) a scheduled cycle (e.g., a certain time or times every one to five days, or weekly) or a periodic cycle (e.g., every few hours or days) in which the controller causes the piezoelectric actuator (or an electromechanical actuator) 260c to switch from the first state to the second state and soon after from the second state back to the first state.

Example system configurations 200E (or Example 5) in FIG. 2E and example system configurations 200F (or Example 6) in FIG. 2F are otherwise similar, if not identical, to example system configurations 200A-200D (or Examples 1-4) in FIGS. 2A-2D in terms of operation and function in the first and second states of devices 225a-225f.

In example system configurations 200G (or Example 7) in FIG. 2G, device 225g includes an unbalanced optical fiber splitter 260e that splits optical fiber segment 235a into optical fiber segments 235b and 235a′, where optical fiber segment 235b carries optical signal(s) 255b at a first power level and optical fiber segment 235a′ carries optical signal(s) 255a′″ at a second power level, the first power level being greater than the second power level in a ratio that is one of 60/40, 70/30, 75/25, 80/20, 85/15, or 90/10. Device 225g further includes optical fiber segment 235a′ a micromirror device 260a, a controller 270, and a photovoltaic component and capacitor-based power source 275c. When in the first state, micromirror device 260a reflects optical signal 255a′″ toward photovoltaic component and capacitor-based power source 275c, which converts the optical power into electrical power and stores the electrical power to provide power to controller 270. Controller 270 causes micromirror device 260a to switch between the first state and the second state according to one of the following:
(I) a separate control signal (either from the optical signal source in the form of a control signal like control signal(s) 255a′ of FIGS. 2B and 2D, or from another control source);
(II) a power-based control where charging and discharging of the photovoltaic component and capacitor-based power source 275c causes the controller 270 to cause the micromirror device 260a to switch from the first state to the second state and from the second state back to the first state, respectively (which is opposite to the operation of the photovoltaic component and capacitor-based power source 275c of FIG. 2F); or
(III) a scheduled cycle (e.g., a certain time or times every one to five days, or weekly) or a periodic cycle (e.g., every few hours or days) in which the controller causes the micromirror device 260a to switch from the first state to the second state and soon after from the second state back to the first state.

When in the second state, micromirror device 260a reflects optical signal 255a′″ as reflected optical signal(s) 280a back along optical fiber segment 235a′ toward unbalanced optical fiber splitter 260e, which relays the reflected optical signal(s) 280a back along optical fiber segment 235a toward main detector 215 via optical splitter 245a. Optical fiber segment 235b also carries reflected optical signal(s) 280b from downstream devices 225, and the unbalanced optical fiber splitter 260e relays the reflected optical signal(s) 280b (in some cases, combining with reflected optical signal(s) 280a) back along optical fiber segment 235a toward main detector 215 via optical splitter 245a.

Device 225h of example system configurations 200H (or Example 8) in FIG. 2H is similar, if not identical, to device 225g of example system configurations 200G (or Example 7) in FIG. 2G, except that instead of the micromirror device 260a, the controller 270, and the photovoltaic component and capacitor-based power source 275c, device 225h further includes a shifter/modulator 260f and mirror 260g. In examples, shifter/modulator 260f may include one or more of a phase shifter, a polarization shifter, an amplitude shifter, an electro-optic modulator, or an acousto-optic modulator, and/or the like. Instead of switching states, device 225g constantly reflects optical signal(s) 255a″″ as reflected optical signal(s) 280a, except that reflected optical signal(s) 280a is shifted and/or modulated in terms of phase, polarization, and/or amplitude compared with optical signal(s) 255a″″, and optical splitter 245a may be further configured to utilize this change in phase, polarization, and/or amplitude as a filter for splitting the reflected optical signal(s) 280a toward the main detector 215.

Example system configurations 200G (or Example 7) in FIG. 2G and example system configurations 200H (or Example 8) in FIG. 2H are otherwise similar, if not identical, to example system configurations 200A-200F (or Examples 1-6) in FIGS. 2A-2F in terms of operation and function of devices 225a-225h (except that device 225h is constantly in the second state).

Device 225i of example system configurations 200I (or Example 9) in FIG. 2I is similar, if not identical, to device 225e of example system configurations 200E (or Example 5) in FIG. 2E, except that instead of the piezoelectric actuator (or an electromechanical actuator) 260c and the corresponding lateral-moving mirror 260d, device 225i further includes tiltable mirror 260h that is caused to tilt or switch between first and second states. In the first state, a mirror surface of the tiltable mirror 260h is caused to tilt out of the path of the optical signals transmitted through the optical fiber transmission path along optical fiber segments 235a and 235b. In the second state, the mirror surface of the tiltable mirror 260h is caused to tilt into the path of the optical signals transmitted through the optical fiber transmission path along optical fiber segments 235a.

Similar to the case in Example 5 of FIG. 2E, when the power of the optical signal(s) 255a diminishes to a point that the capacitor-based power source 275b is no longer being charged and begins to discharge (e.g., below a threshold power level), the capacitor-based power source 275b signals controller 270. In this case, controller 270 causes the tiltable mirror 260h to switch from the first state to the second state, by causing the mirror surface of the tiltable mirror 260h to shift into the path of the optical signals transmitted through the optical fiber transmission path along optical fiber segments 235a. The mirror surface of the tiltable mirror 260h reflects the optical signal(s) 255a as reflected optical signal 280a. When the power of the optical signal(s) 255a once again rises to a point that the capacitor-based power source 275b is once again charged (e.g., above the threshold power level), the capacitor-based power source 275b signals controller 270, which causes the tiltable mirror 260h to switch from the second state back to the first state, by causing the mirror surface of the tiltable mirror 260h to shift out of the path of the optical signals transmitted through the optical fiber transmission path along optical fiber segments 235a. Example system configurations 200I (or Example 9) in FIG. 2I is otherwise similar, if not identical, to example system configurations 200A-200H (or Examples 1-8) in FIGS. 2A-2H in terms of operation and function in the first and second states of devices 225a-225i (except that device 225h is constantly in the second state).

With reference to example system configurations 200J (or Example 10) in FIG. 2J, device 225j includes optical splitter 245b, micromirror device 260a, a controller 270, and a photovoltaic component and capacitor-based power source 275c. Optical splitter 245b splits optical signal(s) 255a into optical signal(s) 255b and optical signal(s) 255a′″″ (which has a lower power than optical signal(s) 255b). When in the first state, micromirror device 260a reflects optical signal 255a′″″ toward photovoltaic component and capacitor-based power source 275c, which converts the optical power into electrical power and stores the electrical power to provide power to controller 270. Controller 270 causes micromirror device 260a to switch between the first state and the second state according to one of the following:
(I) a separate control signal (either from the optical signal source in the form of a control signal like control signal(s) 255a′ of FIGS. 2B and 2D, or from another control source);
(II) a power-based control where charging and discharging of the photovoltaic component and capacitor-based power source 275c causes the controller 270 to cause the micromirror device 260a to switch from the first state to the second state and from the second state back to the first state, respectively (which is identical to the operation of the photovoltaic component and capacitor-based power source 275c of FIG. 2G); or
(III) a scheduled cycle (e.g., a certain time or times every one to five days, or weekly) or a periodic cycle (e.g., every few hours or days) in which the controller causes the micromirror device 260a to switch from the first state to the second state and soon after from the second state back to the first state.

When in the second state, micromirror device 260a reflects optical signal 255a′″″ as reflected optical signal(s) 280a back toward optical splitter 245b, which reflects the reflected optical signal(s) 280a back along optical fiber segment 235a toward main detector 215 via optical splitter 245a. Example system configurations 200J (or Example 10) in FIG. 2J is otherwise similar, if not identical, to example system configurations 200A-200I (or Examples 1-9) in FIGS. 2A-2I in terms of operation and function in the first and second states of devices 225a-225j (except that device 225h is constantly in the second state).

In some aspects, micromirror devices (such as micromirror devices 260a of FIGS. 2A-2D, 2G, and 2J), during the second state, may be configured (and controlled by controller 270) to shift position to reflect portions of the optical signal(s) (in this case, optical signal(s) 255a, 255a′″, and 255a′″″) in a high frequency manner to send a return signal (i.e., optical signal(s) 280a) containing pulses corresponding to portions of the optical signal(s) 255a, 255a′″, and 255a′″″. In some examples, the return signal includes a digital representation of one or more of an identifier, a numeric code, an alphanumeric code, or a status message that is associated with that device (in this case, one of devices 225a-225d, 225g, and 225j).

In another aspect, from one end of the fiber optic cable, a light source is disabled for a predetermined length of time to discharge a photovoltaic component in an end device. Once this device is discharged, a digital micromirror resumes a position reflecting light back toward the source. A burst of light is then sent over the fiber cable reflecting light back, which can be pulsed through microcircuitry charged by the photovoltaic component to send a short identifier or merely a fixed length burst via the micromirror, after which the micromirror is toggled out of position, allowing light communication to continue unobstructed. Layering this technique can be used to isolate faults through purely passive components as mirrors at different layers are positioned out of the path at each layer in the path.

Although particular system configurations are shown in FIGS. 2A-2J, other system configurations may be used for reflecting optical signals back to the main detector, and for the main detector and/or source controller to identify issues (e.g., failures, breaks, faults, etc.) along particular portions or segments of the optical fiber transmission path.

FIG. 3 depicts a flow diagram illustrating an example method 300 for implementing detection of optical fiber segment failure using optical signal loopback, in accordance with various embodiments.

In the non-limiting embodiment of FIG. 3, method 300, at operation 305, may include a first device (e.g., one of devices 125a-125n of FIG. 1, or the like), which is placed along an optical fiber transmission path (e.g., optical fiber transmission path 150 of FIG. 1, or the like), receiving a first optical signal (e.g., one of optical signals 155a-155n of FIG. 1, or the like) that is transmitted over at least a first segment of an optical fiber cable (e.g., at least one of optical fiber segments 135a-135n of FIG. 1, or the like) from an optical signal source (e.g., optical signal source 110 of FIG. 1, or the like). At operation 310, the first device directs transmission of the first optical signal, by: (a) when in a first state, causing transmission of the first optical signal to continue along the optical fiber transmission path over at least a second segment of the optical fiber cable toward a destination optical terminal (e.g., destination terminal(s) 130 of FIG. 1, or the like) (at operation 315); and (b) when in a second state, causing at least a portion of the first optical signal to be reflected (e.g., one of reflected optical signals 180a-180n of FIG. 1, or the like) back along the optical fiber transmission path over at least the first segment of the optical fiber cable back toward the optical signal source (at operation 320). In examples, the first optical signal that is reflected back is detected using a main detector (e.g., main detector 115 of FIG. 1, or the like) that is located between the optical signal source and the first device. At operation 325, the processes at operations 305-320 are repeated for each of the other devices (e.g., one or more other devices among the plurality of devices 125a-125n of FIG. 1, or the like), in sequence, e.g., from the optical signal source toward the destination optical terminal. At operation 330, the main detector detects which optical fiber segment among the plurality of optical fiber segments has a break, by determining which device among the plurality of devices fails to send back a reflected optical signal.

FIG. 4 depicts a flow diagram illustrating another example method 400 for implementing detection of optical fiber segment failure using optical signal loopback, in accordance with various embodiments.

In the non-limiting embodiment of FIG. 4, method 400, at operation 405, may include an optical signal source (e.g., optical signal source 110 of FIG. 1, or the like) transmitting a first optical signal (e.g., one of optical signals 155a-155n of FIG. 1, or the like) over at least a first segment of a plurality of optical fiber segments of an optical fiber cable (e.g., at least one of optical fiber segments 135a-135n of FIG. 1, or the like) to each device, in sequence, among a plurality of devices (e.g., the plurality of devices 125a-125n of FIG. 1, or the like). Each device is communicatively coupled with a next device by one of the plurality of optical fiber segments of the optical fiber cable (e.g., one of optical fiber segments 135b-135n of FIG. 1, or the like), the plurality of devices and the plurality of optical fiber segments defining an optical fiber transmission path (e.g., optical fiber transmission path 150 of FIG. 1, or the like) between the optical signal source and at least one destination optical terminal (e.g., destination terminal(s) 130 of FIG. 1, or the like).

At operation 410, for each device, in sequence, that device receives the first optical signal (at operation 415), and, while in a first state, causes transmission of the first optical signal to continue along the optical fiber transmission path over a next segment among the plurality of optical fiber segments of the optical fiber cable (e.g., one of optical fiber segments 135b-135n of FIG. 1, or the like) toward the at least one destination optical terminal (at operation 420). Method 400 repeats the processes at operations 415 and 420 for the next device along the optical fiber transmission path toward the at least one destination optical terminal, and then for the device after that, and so on.

At operation 425, the optical signal source transmits a second optical signal over at least the first segment of the optical fiber cable to each device, in sequence. The second optical signal is transmitted after transmission of the first signal. At a typical transmission speed of about 200,000 km in an optical fiber cable having a typical refractive index of about 1.46, depending on the distance of the optical signal source and each of the at least one destination optical terminal (e.g., hundreds, thousands, or hundreds of thousands of kilometers), and how short a duration between transmission of the first and second optical signals (e.g., milliseconds, microseconds, nanoseconds, etc.), both optical signals may be concurrently carried over the optical fiber transmission path (e.g., at either ends of the optical fiber transmission path), assuming no breaks in a segment(s) of the optical fiber cable. In other words, operation 425 may be initiated while operations 415 and 420 are proceeding for one or more devices among the plurality of devices (e.g., devices closer to the at least one destination optical terminal). In examples, the second optical signal contains a first control signal that triggers at least one device to switch states from the first state to a second state.

At operation 430, for each device, in sequence, that device receives the second optical signal (at operation 435), and, based on a determination that the first control signal contained in the second optical signal is directed to that device, switches from the first state to the second state (at operation 440). At operation 445, while in the second state, that device causes at least a portion of the second optical signal to be reflected back (e.g., as a reflected optical signal) along the optical fiber transmission path over at least the first segment of the optical fiber cable back toward the optical signal source. After causing the at least a portion of the second optical signal to be reflected back toward the optical signal source, that device switches from the second state back to the first state (at operation 450). In some examples, switching back to the first state occurs either after that device determines that reflecting the at least the portion of the second optical signal is completed, after a default time corresponding to a signal pulse duration of optical signals has elapsed, or after receiving a third optical signal containing a second control signal that triggers the at least one device (or that device in particular) to switch states from the second state to the first state. Method 400 repeats the processes at operations 435 through 450 for the next device along the optical fiber transmission path toward the at least one destination optical terminal, and then for the device after that, and so on.

At operation 455, which occurs after each of the at least one device causes the at least a portion of the second optical signal to be reflected back (e.g., as the reflected optical signal), a main detector (e.g., main detector 115 of FIG. 1, or the like), which is located proximal to the optical signal source, detects which optical fiber segment among the plurality of optical fiber segments has a break, in some cases, by determining which device among the plurality of devices fails to send back a reflected optical signal. Similar to the process at operation 425, the process at operation 455 can occur concurrent with the processes at operations 435-450, especially for devices closer to the at least one destination optical terminal.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200A-200J of FIGS. 1 and 2A-2J, respectively (or components thereof), such methods may also be implemented using any suitable hardware (or software) implementation. Similarly, while each of the systems, examples, or embodiments 100 and 200A-200J of FIGS. 1 and 2A-2J, respectively (or components thereof), can operate according to the methods 300, 400 (e.g., by executing instructions embodied on a computer readable medium), the systems, examples, or embodiments 100 and 200A-200J of FIGS. 1 and 2A-2J can each also operate according to other modes of operation and/or perform other suitable procedures.

### Exemplary System and Hardware Implementation

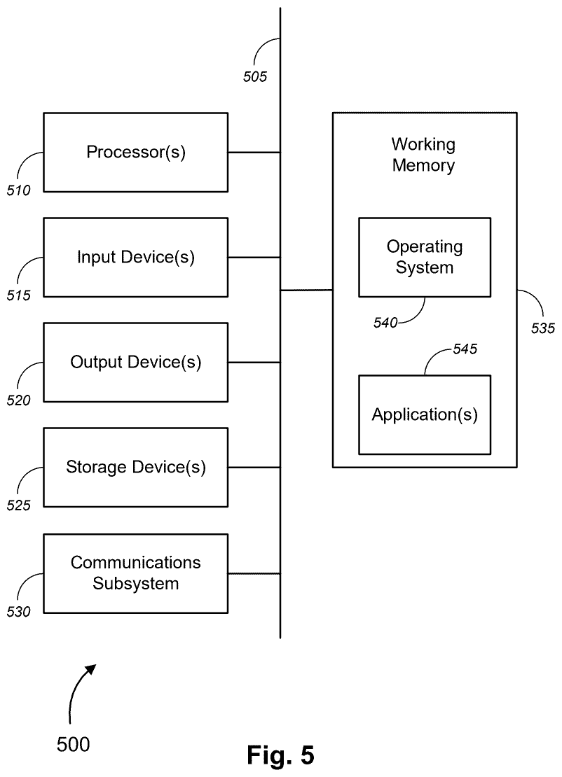

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., source controller 120, local controller 170, destination controller 195, and controller 270, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., source controller 120, local controller 170, destination controller 195, and controller 270, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a first device that is placed along an optical fiber transmission path, a first optical signal that is transmitted over at least a first segment of an optical fiber cable from an optical signal source; and
directing, by the first device, transmission of the first optical signal, by:
when in a first state, causing transmission of the first optical signal to continue along the optical fiber transmission path over at least a second segment of the optical fiber cable toward a destination optical terminal; and
when in a second state, causing at least a portion of the first optical signal to be reflected back along the optical fiber transmission path over at least the first segment of the optical fiber cable back toward the optical signal source, the first optical signal that is reflected back being detected using a main detector that is located between the optical signal source and the first device.

2. The method of claim 1, wherein the optical fiber cable includes a plurality of optical fiber segments, wherein the plurality of optical fiber segments includes the first segment and the second segment of the optical fiber cable, wherein the optical fiber transmission path is defined by the plurality of optical fiber segments and a plurality of devices, wherein each of the plurality of devices is communicatively coupled with a next device by one of the plurality of optical fiber segments, wherein the plurality of devices includes the first device, wherein each of the plurality of devices is functionally identical to the first device, wherein the method further comprises:
detecting which optical fiber segment among the plurality of optical fiber segments has a break, by determining which device among the plurality of devices fails to send back a reflected optical signal.

3. The method of claim 2, wherein each optical fiber segment is a separate optical fiber cable, and each optical fiber cable communicatively couples with a corresponding device among the plurality of devices via optical fiber connectors.

4. The method of claim 1, wherein the first device includes a micromirror device that is triggered to switch between the first state and the second state in response to receiving a control signal that signals one of:
to switch between the first state and the second state;
to switch from the first state to the second state; or
to switch from the second state to the first state.

5. The method of claim 4, wherein the control signal is one of:
a first control signal contained in one of the first optical signal or a second optical signal that is transmitted from the optical signal source;
a second control signal that is sent by a local detector, which is coupled to and in proximity of the first device, that detects the first control signal contained in the one of the first optical signal or the second optical signal from the optical signal source; or
a third control signal that is sent by the local detector that detects a change in power level of optical signals transmitted over the optical fiber transmission path.

6. The method of claim 1, wherein the first device is powered by a photovoltaic component that converts power from optical signals that are transmitted over the optical fiber cable into electrical power,
wherein the first device, when powered by the photovoltaic component, is set to the first state,
wherein, when power provided by the photovoltaic component decreases below a threshold power level, the first device is caused to transition from the first state to the second state, and
wherein, when power provided by the photovoltaic component increases from below to above the threshold power level, the first device is caused to transition from the second state to the first state.

7. The method of claim 6, wherein the first optical signal is split from a first portion carried by at least the first segment of the optical fiber cable into a second portion that is carried by a second optical fiber cable within the first device, wherein the photovoltaic component is one of:
a photovoltaic material that is disposed on an inner portion of either the first segment of the optical fiber cable over which the first portion of the first optical signal is transmitted or the second optical fiber cable that carries the second portion of the first optical signal; or
a photovoltaic collector that receives the second portion of the first optical signal that is split from the optical fiber cable.

8. The method of claim 6, wherein the first device is one of:
a micromirror device that switches between:
reflecting optical signals to be transmitted over the optical fiber transmission path toward the destination optical terminal; and
reflecting optical signals to be transmitted over the optical fiber transmission path back toward the optical signal source; or
a movable mirror attached to a piezoelectric actuator that switches between:
shifting the movable mirror out of the optical fiber transmission path to allow optical signals to be transmitted over the optical fiber transmission path toward the destination optical terminal; and
shifting the movable mirror into the optical fiber transmission path to cause optical signals to reflect off the movable mirror and to be transmitted over the optical fiber transmission path back toward the optical signal source.

9. The method of claim 1, wherein the first device includes an unbalanced optical fiber splitter that splits the optical fiber cable into:
a third optical fiber cable that carries the first optical signals, at a first power level, along the optical fiber transmission path toward the destination optical terminal; and
a fourth optical fiber cable that carries a portion of the first optical signals, at a second power level, along a split path that includes a reflector that reflects the portion of the first optical signals over the optical fiber cable along the optical fiber transmission path back toward the optical signal source,
wherein the first power level is greater than the second power level, and wherein the reflector includes one of a micromirror device, a mirror/splitter, or a combination of a mirror/splitter and one or more of a phase shifter, a polarization shifter, an amplitude shifter, an electro-optic modulator, or an acousto-optic modulator.

10. The method of claim 1, the first device includes a micromirror device that, during the second state, shifts position to reflect portions of the first optical signal in a high frequency manner to send a return signal containing pulses corresponding to portions of the first optical signal, wherein the return signal includes a digital representation of one or more of an identifier, a numeric code, an alphanumeric code, or a status message that is associated with that device.

11. A system, comprising:
an optical signal source;
a main detector that is located proximal to the optical signal source; and
a plurality of devices, each of which is communicatively coupled with a next device by one of a plurality of optical fiber segments of an optical fiber cable, the plurality of devices and the plurality of optical fiber segments defining an optical fiber transmission path between the optical signal source and at least one destination optical terminal;
wherein the optical signal source transmits optical signals along the optical fiber transmission path over at least a first segment of the plurality of optical fiber segments of the optical fiber cable to each device in sequence;
wherein each device directs transmission of the optical signals, by:
when in a first state, causing transmission of the optical signals to continue along the optical fiber transmission path over a next segment among the plurality of optical fiber segments of the optical fiber cable toward the at least one destination optical terminal; and
when in a second state, causing at least a portion of the optical signal to be reflected back along the optical fiber transmission path over at least the first segment of the optical fiber cable back toward the optical signal source; and
wherein the main detector detects which optical fiber segment among the plurality of optical fiber segments has a break, by determining which device among the plurality of devices fails to send back a reflected optical signal.

12. The system of claim 11, wherein the optical signal source sends a control signal contained in the optical signals transmitted along the optical fiber transmission path over at least the first segment of the optical fiber cable, the control signal triggering at least one device to switch states by performing one of:
switching between the first state and the second state;
switching from the first state to the second state; or
switching from the second state to the first state.

13. The system of claim 12, wherein the control signal triggers a specific one of the plurality of devices to switch states, wherein each device includes a local detector that detects and decodes control signals to determine whether the control signal contains code directed to that device.

14. The system of claim 13, wherein each device further includes a reflector that reflects the control signal containing the code directed to that device, wherein the main detector determines which device has failed based on which devices have reflected back their corresponding codes.

15. The system of claim 12, wherein the control signal is a general control signal that triggers each device in sequence to switch states, wherein each device includes a reflector having a reflective surface, wherein, during the second state, the reflector that causes shifting of the reflective surface to reflect portions of the control signal in a high frequency manner to send a return signal containing pulses corresponding to portions of the control signal, wherein the return signal includes a digital representation of one or more of an identifier, a numeric code, an alphanumeric code, or a status message that is associated with that device.

16. The system of claim 11, wherein each of at least one device among the plurality of devices is powered by a photovoltaic component that converts power from the optical signals that are transmitted over the optical fiber cable into electrical power,
wherein that device, when powered by the photovoltaic component, is set to the first state,
wherein, when power provided by the photovoltaic component decreases below a threshold power level, that device is caused to transition from the first state to the second state, and
wherein, when power provided by the photovoltaic component increases from below to above the threshold power level, that device is caused to transition from the second state to the first state.

17. The system of claim 16, wherein the optical signals are split from a first portion carried by at least the first segment of the optical fiber cable into a second portion that is carried by a second optical fiber cable within that device, wherein the photovoltaic component is one of:
a photovoltaic material that is disposed on an inner portion of either the first segment of the optical fiber cable over which the first portion of the optical signals is transmitted or the second optical fiber cable that carries the second portion of the optical signals; or
a photovoltaic collector that receives the second portion of the optical signals that is split from the optical fiber cable.

18. The system of claim 11, wherein each of the plurality of devices includes one of:
a micromirror device that switches between:
reflecting optical signals to be transmitted over the optical fiber transmission path toward the destination optical terminal; and
reflecting optical signals to be transmitted over the optical fiber transmission path back toward the optical signal source;
a movable mirror attached to a piezoelectric actuator that switches between:
shifting the movable mirror out of the optical fiber transmission path to allow optical signals to be transmitted over the optical fiber transmission path toward the destination optical terminal; and
shifting the movable mirror into the optical fiber transmission path to cause optical signals to reflect off the movable mirror and to be transmitted over the optical fiber transmission path back toward the optical signal source; or
an unbalanced optical fiber splitter that splits the optical fiber cable into:
a third optical fiber cable that carries the optical signals, at a first power level, along the optical fiber transmission path toward the at least one destination optical terminal; and
a fourth optical fiber cable that carries a portion of the optical signals, at a second power level, along a split path that includes a reflector that reflects the portion of the optical signals over the optical fiber cable along the optical fiber transmission path back toward the optical signal source,
wherein the first power level is greater than the second power level, and wherein the reflector includes one of the micromirror device, a mirror/splitter, or a combination of a mirror/splitter and one or more of a phase shifter, a polarization shifter, an amplitude shifter, an electro-optic modulator, or an acousto-optic modulator.

19. A method, comprising:
transmitting, by an optical signal source, a first optical signal over at least a first segment of a plurality of optical fiber segments of an optical fiber cable to each device, in sequence, among a plurality of devices, wherein each device is communicatively coupled with a next device by one of the plurality of optical fiber segments of the optical fiber cable, the plurality of devices and the plurality of optical fiber segments defining an optical fiber transmission path between the optical signal source and at least one destination optical terminal;
for each device, in sequence,
receiving, by that device, the first optical signal; and
while in a first state, causing, by that device, transmission of the first optical signal to continue along the optical fiber transmission path over a next segment among the plurality of optical fiber segments of the optical fiber cable toward the at least one destination optical terminal;
transmitting, by the optical signal source, a second optical signal over at least the first segment of the optical fiber cable to each device, in sequence, wherein the second optical signal contains a first control signal that triggers at least one device to switch states from the first state to a second state;
for each device, in sequence,
receiving, by that device, the second optical signal;
based on a determination that the first control signal contained in the second optical signal is directed to that device, switching, by that device, from the first state to the second state; and
while in the second state, causing at least a portion of the second optical signal to be reflected back along the optical fiber transmission path over at least the first segment of the optical fiber cable back toward the optical signal source; and
detecting, by a main detector that is located proximal to the optical signal source, which optical fiber segment among the plurality of optical fiber segments has a break, by determining which device among the plurality of devices fails to send back a reflected optical signal.

20. The method of claim 19, wherein, after causing the at least a portion of the second optical signal to be reflected back toward the optical signal source, each device switches from the second state to the first state, either after that device determines that reflecting the at least the portion of the second optical signal is completed, after a default time corresponding to a signal pulse duration of optical signals has elapsed, or after receiving a third optical signal containing a second control signal that triggers the at least one device to switch states from the second state to the first state.
